(19) United States
(12) Patent Application Publication
(10) Pub. No.: US 2006/0093156 A1
(43) Pub. Date: May 4, 2006

(54) Sound diffuser, in particular for high fidelity sound reproduction systems

(76) Inventor: Stefano Caniggia, Milano (IT)

Correspondence Address: JACOBSON HOLMAN PLLC, 400 SEVENTH STREET N.W., SUITE 600, WASHINGTON, DC, 20004, US

(21) Appl. No.: 11/261,496

(22) Filed: Oct. 31, 2005

(30) Foreign Application Priority Data
Nov. 4, 2004 (IT) MI2004U000493

(51) Int. Cl. H04R 1/02; H04R 25/00

(52) U.S. Cl. 381/89; 381/182

(57) ABSTRACT

There is described a sound diffuser, in particular for high fidelity sound reproduction systems, which comprises two speakers (1, 2) having diffusing cones (3) oriented in the same direction. The two speakers (1, 2) are electrically connected with each other either in antiparallel or in antiseries. Each speaker (1, 2) has polar expansions (8, 9) with magnetic polarities reversely arranged with respect to the other speaker.

The present invention relates to a structure of sound diffuser, in particular for high fidelity sound reproduction systems.

When making sound diffusion systems in high fidelity sound systems it is necessary to emit a sound that is as linear as possible and with adequate volume.

Among the problems that the designer of sound diffusers must face, there is the so called emphasis phenomenon due to the counter electromotive force, to which the cone or membrane of the speaker is subjected.

Task of the present invention is to provide a structure of sound diffuser which eliminates the inconveniencies of the traditional speakers.

Within the sphere of this task, an object of the invention is to provide a structure of sound diffuser, which is able to provide a more linear and therefore truer sound, as compared with traditional diffusers with similar performances.

An additional object is to provide a simple structure, both from the mechanical point of view and as regards the electric contacts.

These and other objects, which will be better evidenced hereinafter, have been attained by a sound diffuser, in particular for high fidelity sound reproduction systems, characterised in that it comprises two speakers having diffusing cones oriented in the same direction, said speakers being electrically connected with each other either in antiparallel or in antiseries, each speaker having polar expansions with magnetic polarities reversely arranged with respect to the other speaker.

Additional characteristics and advantages of the subject-matter of the present invention will become more evident from the description of a preferred, but not exclusive embodiment of the invention, which is illustrated as an indicative and non-limiting example in the enclosed drawings in which:

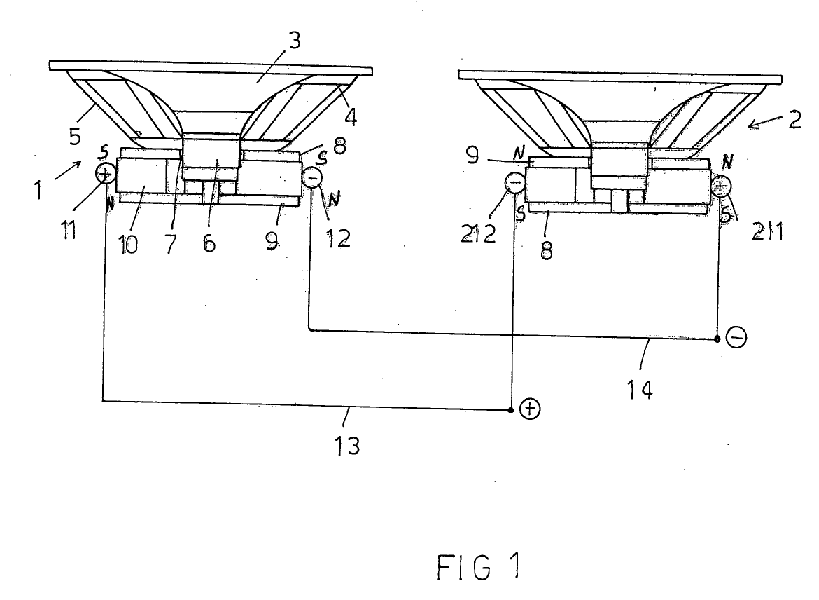

FIG. 1 shows an antiparallel connection of two speakers in a sound diffuser according to the invention;

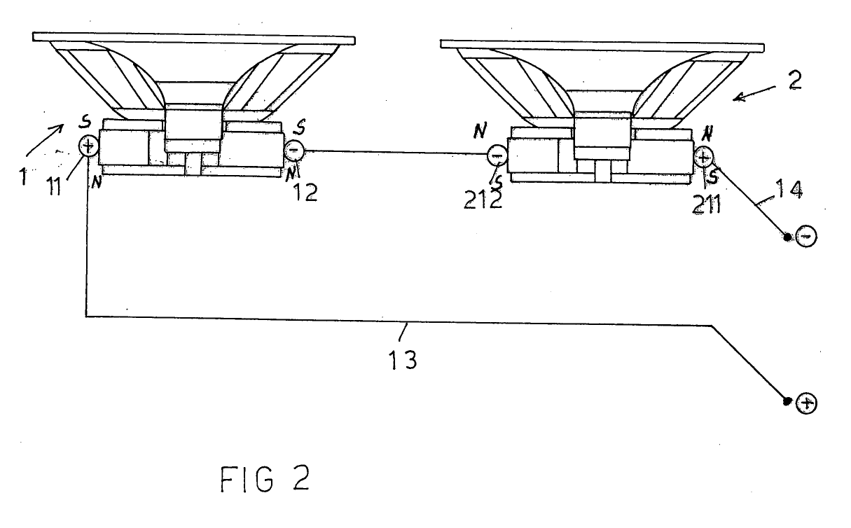

FIG. 2 shows an antiseries connection of two speakers in a sound diffuser according to the invention;

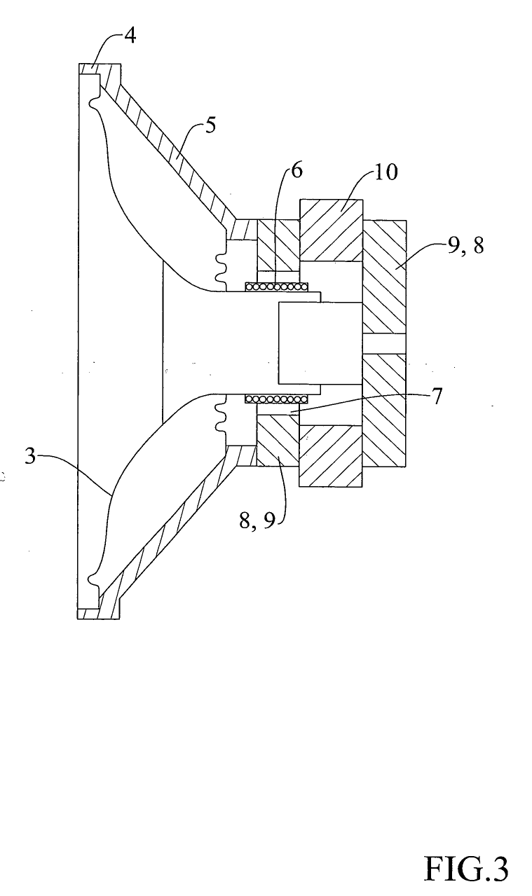

FIG. 3 shows a sectional view of a speaker of the sound diffuser of FIGS. 1 and 2.

With particular reference to the numeric symbols of the aforementioned figures, the structure of sound diffuser according to the invention comprises the electric connection of two speakers oriented in the same direction, respectively indicated by the reference numbers 1 and 2, either in antiparallel, as visible in FIG. 1, or in antiseries, as visible in FIG. 2.

Each speaker comprises, in a way known per se, a diffusing cone formed by a membrane 3, mounted onto a suspension 4, associated with a basket 5.

The membrane 3 is integral with a mobile coil 6 mounted in a magnetic gap 7 of a magnet 10, between two polar expansions 8 and 9, which have magnetic polarities reversely arranged in the two speakers 1 and 2, respectively.

The electric connections are made by means of two terminals, respectively positive 11 and negative 12 in the speaker 1, positive 211 and negative 212 in the speaker 2.

According to the invention the antiparallel connection, visible in FIG. 1, is obtained by connecting the positive wire 13, coming from an amplifier, not visible in the figure, with the positive terminal 11 of the first speaker and with the negative terminal 212 of the second speaker, and by connecting the negative wire 14 coming from the amplifier with the negative terminal 12 of the first speaker and with the positive terminal 211 of the second speaker.

According to the invention, the antiseries connection, visible in FIG. 2, is obtained by connecting the positive wire 13, coming from the amplifier, not visible in the figure, with the positive terminal 11 of the first speaker and the negative wire 14 coming from the amplifier with the positive terminal 211 of the second speaker 2.

In addition the negative terminal 12 of the first speaker 1 is connected with the negative terminal 212 of the second speaker 2.

In practice it has been observed that the invention attains the pre-established task and objects.

In fact a structure of sound diffuser is obtained, capable to provide a sound more linear and closer to the sum of the two.

Such result depends on the damping of the counter-electromotive force, which causes, in traditional systems, sound emphasis phenomena.

Naturally the materials which were utilised, as well as the dimensions, can be any according to the needs and the state of the art.

1. Sound diffuser, in particular for high fidelity sound reproduction systems, characterised in that it comprises two speakers (1, 2) having diffusing cones (3) oriented in the same direction, said speakers (1, 2) being electrically connected with each other either in antiparallel or in antiseries, each speaker (1, 2) having polar expansions (8, 9) with magnetic polarities reversely arranged with respect to the other speaker.

2. Sound diffuser according to claim 1, characterised in that in the antiparallel connection a positive wire (13) coming from an amplifier is connected with a positive terminal (11) of a first speaker (1) and with a negative terminal (212) of a second speaker (2), and a negative wire (14) coming from the amplifier is connected with a negative terminal (12) of the first speaker (1) and with a positive terminal (211) of the second speaker.

3. Sound diffuser according to claim 1, characterised in that in the antiseries connection a positive wire (13) coming from an amplifier is connected with a positive terminal (11) of a first speaker (1) and a negative wire (14) coming from the amplifier is connected with a positive terminal (211) of a second speaker (2), and a negative terminal (12) of the first speaker (1) is connected with a negative terminal (212) of the second speaker (2).
